(19) United States
(12) Patent Application Publication
(10) Pub. No.: US 2004/0224727 A1
(43) Pub. Date: Nov. 11, 2004

(54) International call indicator

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: PATTI & BRILL, ONE NORTH LASALLE STREET, 44TH FLOOR, CHICAGO, IL, 60602, US

(21) Appl. No.: 10/434,851

(22) Filed: May 9, 2003

(51) Int. Cl. H04M 1/00

(52) U.S. Cl. 455/567; 455/415

(57) ABSTRACT

A method and system in a telecommunications network for: receiving an incoming call for a mobile phone; determining a country code associated with the incoming call; determining a country code associated with the mobile phone; comparing the country code associated with the incoming call to the country code associated with the mobile phone; determining that the incoming call is an international call, when the country code associated with the incoming call is different from the country code associated with the mobile phone; and determining that the incoming call is an in-country call, when the country code associated with the incoming call substantially matches the country code associated with the mobile phone. The system implements the method.

### TECHNICAL FIELD

The present invention relates to wireless telephony in general, and, more particularly, to a method and system for indicating, on a mobile phone in a telecommunications network, that an incoming call is an international call.

### BACKGROUND OF THE INVENTION

Wireless telephones, which include both cellular telephones and the higher frequency personal communication devices (PCDs), are growing in numbers and also shrinking in size and weight. The growth in numbers is influenced by the convenience and the per call cost of wireless telephones with respect to pagers and wire line telephones or coin telephones for completing calls, especially when the user is away from home or office. The shrinking size is influenced by two related technologies: more efficient receive/transmit processing circuits and higher power density batteries.

Telephone service subscribers do not necessarily want to answer all the telephone calls they receive. However, in order to know what calls they are interested in answering, subscribers must know who is calling. Presently available systems display, on a special display device associated with a subscriber's telephone, the caller's phone number and billing name of the caller. This special display device is available integrated with a telephone in a single telephonic unit or as a device connected separately to an existing telephone.

The name of the person or entity associated with the phone number can be found by a reverse directory lookup of the number in the telephone company's billing information. On some present systems, the name and/or number of the caller can be displayed on the subscriber's display device. In cases where the caller name is displayed, the names that can be displayed are limited to those that can be retrieved from the telecommunications network directory. The visual display approach uses a data modem signal that is transmitted by the central office on the subscriber's line between the first and second ring. This necessitates a modem to encode the data at the subscriber's central office Service Switching Point and a modem built-in with the display logic at the subscriber's receiving location.

However, there are many calls, such as, telemarketing calls and international calls, which are often delivered with the caller ID equal to “unknown”. It is well known that answering calls from telemarketers may be annoying, disruptive and time consuming. By checking the caller ID display, calls that are identified as “unknown” may be left unanswered by a user, especially a mobile phone user, to avoid the telemarketers calls. However, those users that desire to answer international calls may miss such calls, since the caller ID system also usually identifies these calls as “unknown”. That is, the caller ID system cannot, or by caller choice may not, display the number or the caller name of an incoming call. In this situation, the call ID display typically displays “unknown”.

Thus, it is a drawback of the prior art that the caller ID system does not identify incoming international calls, except for the “unknown” designation. Thus, there is a need in the art for an improved method and system for indicating, especially on a mobile phone, that an incoming call is an international call. In particular, there is a need in the art for indicating, especially on a mobile phone, that an incoming call is an international call even when the caller ID display shows that the caller is “unknown”.

### SUMMARY

The following summary of embodiments of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present method and system to provide a method and system for indicating, especially on a mobile phone in a telecommunications network, that an incoming call is an international call.

It is a further aspect of the present method and system to provide for indicating, especially on a mobile phone, that an incoming call is an international call when a country code of a caller is different than a country code associated with the mobile phone.

It is still a further aspect of the present method and system to provide for indicating, especially on a mobile phone, that an incoming call is an international call even when the caller ID display shows that the caller is “unknown”.

In general terms the method in a telecommunications network is for receiving, in a telecommunication network, an incoming call for a mobile phone; determining a country code associated with the incoming call; determining a country code associated with the mobile phone; comparing the country code associated with the incoming call to the country code associated with the mobile phone; determining that the incoming call is an international call, when the country code associated with the incoming call is different from the country code associated with the mobile phone; and determining that the incoming call is an in-country call, when the country code associated with the incoming call substantially matches the country code associated with the mobile phone.

In general terms the system in a telecommunications network is for receiving, in a telecommunication network, an incoming call for a mobile phone. The system comprises a country code associated with the incoming call; a database having mobile phone to country code associations; a country code associated with the mobile phone; a comparison module that receives data indicative of the country code associated with the incoming call and data indicative of the country code associated with the mobile phone; an indicator at the mobile phone that signals, when the country code associated with the incoming call is different from the country code associated with the mobile phone, that the incoming call is an international call.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 depicts a block diagram illustrative of a mobile switching center, base station and mobile station for use with the present method and system.

FIG. 2 illustrates a block diagram illustrative of a mobile switching center, base station, mobile station and international call identification system according to one embodiment of the present method and system.

FIG. 3 illustrates a very general flow chart of logical operational steps that may be followed in accordance with one embodiment of the present method and system.

FIG. 4 illustrates another flow chart of logical operational steps that may be followed in accordance with one embodiment of the present method and system.

FIG. 5 illustrates yet a further flow chart of logical operational steps that may be followed in accordance with one embodiment of the present method and system.

### DETAILED DESCRIPTION

The particular values and configurations discussed in these non-limiting examples can be varied and are cited merely to illustrate an embodiment of the present invention and are not intended to limit the scope of the invention.

In very general terms the present method indicates that an incoming call is an international call. The method has the steps of: determining that an incoming call is one of an in-country call and an international call; and activating an indicator only when the incoming call is determined to be an international call. As one example, in the European Global System for Mobile communications (GSM), subscribers are allocated a unique International Mobile Subscriber Identity (IMSI) which has a country ID part identifying the country where the subscriber's home network is located, a home network ID part identifying the subscriber's home network, and a subscriber ID part identifying the subscriber within his home network. The code is stored on a Subscriber Identity Module (SIM) card, which is plugged into the subscriber's mobile terminal. Upon registering with a mobile network, the terminal sends the IMSI to the mobile network in order to allow the network operator to verify the identity of the terminal and to establish a billing relationship with the subscriber's home network (if the subscriber is not at home). This authentication process further enables the home network to update its Home Location Register (HLR), which keeps track of the current locations of the home network's subscribers, allowing incoming calls and other signaling information to be forwarded to the correct destination. Other methods may be used for data that identifies a country code of a mobile subscriber (the mobile phone), and that identifies a country code for incoming calls.

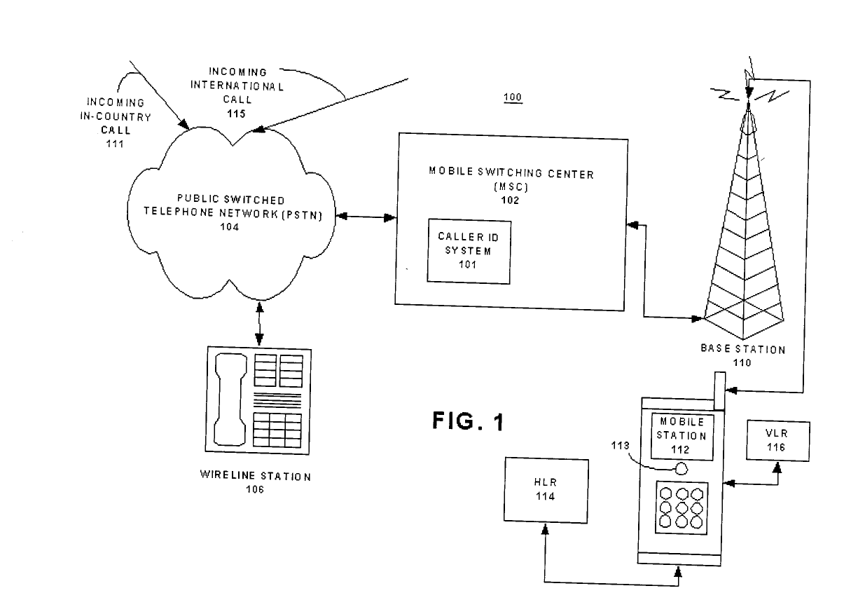

Referring to FIG. 1, a system 100 is depicted for indicating that an incoming call is an international call to mobile handsets (also referred to as mobile phones). System 100 has a mobile switching center (MSC) 102. The system may be, or may be part of, one or more of a telephone network, a local area network (“LAN”), the Internet, and a wireless network. In the depicted embodiment, a public switched telephone network (PSTN) 104 is connected to MSC 102. The PSTN 104 routes calls to and from mobile users through the MSC 102. The PSTN 104 also routes calls from and to wireline stations 106. The MSC 102 is also connected to one or more base stations (BS) 110. Each of the base stations 110 communicates with mobile station(s) 112 in its service area. The PSTN 104 generally can be implemented as the worldwide voice telephone network accessible to all those with telephones and access privileges (e.g., AT&T long distance network).

Each of the mobile stations 112 has a home location register (HLR) 114 where data about each of the mobile stations 112 resides. Some of the mobile stations 112 maybe remotely located from their home location, and in that case, a visiting location register (VLR) 116 is set up locally for each mobile station 112 that is visiting in its service area. HLR 114 can be implemented as a permanent SS7 database utilized in cellular networks, such as, but not limited to, for example, AMPS (Advanced Mobile Phone System), GSM (Global System for Mobile Communications), and PCS.

HLR 114 can be utilized generally to identify/verify a subscriber, and also contains subscriber data related to features and services. HLR 114 is generally utilized not only when a call is being made within a coverage area supported by a cellular provider of record, but also to verify the legitimacy and to support subscriber features when a subscriber is away from his or her home area. VLR 116, on the other hand, can be implemented as a local database maintained by the cellular provider whose territory is being roamed. Mobile station 112 can be implemented as a cellular device, personal communication device, short message service device or wireless communications device (e.g., a wireless personal digital assistant).

The PSTN 104 may receive both in-country calls and international calls. The MCS 102 may have, or be operatively connected to, a caller ID system 101 that provides name and number identification of an incoming call. This name and number information (call ID information) may be transmitted to the mobile station 112 for display thereon. However, there are many calls, such as, telemarketing calls and international calls, which are often delivered with the caller ID information that displays the call as being “unknown”.

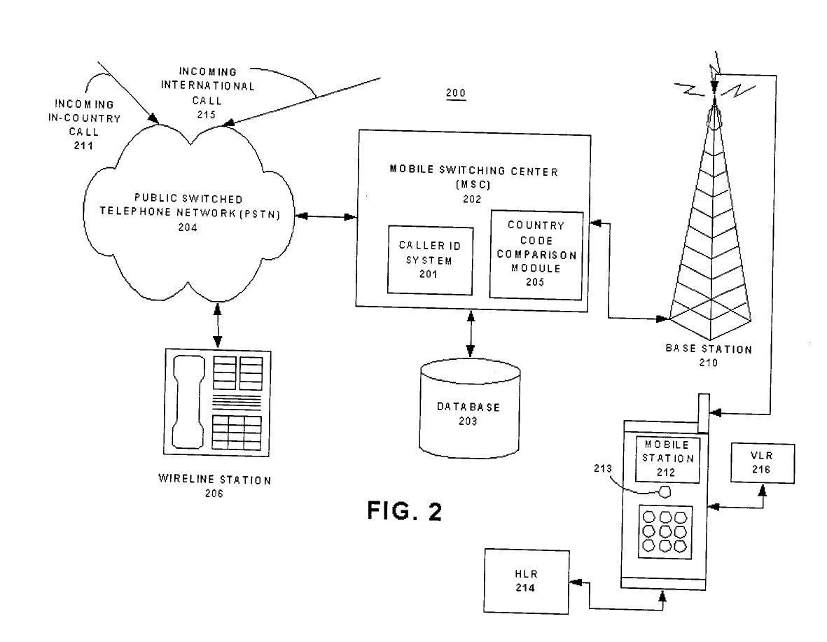

Referring to FIG. 2, a system 200 is shown for indicating that an incoming call is an international call for mobile handsets. FIG. 2 depicts a block diagram that is illustrative of a mobile switching center 202 operatively connected a PSTN 204, a database 203, base station 210, and mobile station 212 according to one embodiment of the present method and system. The PSTN 204 routes calls to and from mobile users through the MSC 202, as well as routing calls from and to wireline stations 206. The MSC 202 is connected to one or more base stations 210. The base station(s) 210 communicates through the air to mobile stations 212, which may be of a cellular telephone type or of the wider bandwidth personal communication device type. Mobile stations 212 may be wireless handsets or automobile mounted stations the same as those shown in FIG. 1.

An incoming call may be an incoming in-country call 211 or an incoming international call 215. A country code is associated with the incoming call, which is received at the MSC 202 via the PSTN 204. The MSC 202 retrieves a country code of the mobile station 212, for which the incoming call is intended, from a database 203 having mobile phone to country code associations. A comparison module 205 in, or operatively connected to, the MSC 202 receives data indicative of the country code associated with the incoming call, and receives data (from HLR 214 or VLR 216) indicative of the country code associated with the mobile phone 212. The comparison module determines that the incoming call is an international call, when the country code associated with the incoming call is different from the country code associated with the mobile phone 212, and determines that the incoming call is an in-country call, when the country code associated with the incoming call substantially matches the country code associated with the mobile phone 212, the comparison module 205 outputting a signal indicative thereof. An indicator 213 at the mobile station 212, in response to the signal, is activated to identify the incoming call as an international call. The indicator may be at least one of a visual display, an audio display and a vibration effect.

The MSC 202 may also have, or be operatively connected to, a caller ID system 201 that supplies the name and number of an incoming call. When the caller ID system 201 cannot supply such information, the incoming call is designated as “unknown”. This typically occurs for telemarketing calls and international calls. The call ID information is displayed at the mobile station 212. However, with the present method and system the user of the mobile phone will know that an incoming cal is an international call even when the caller ID shows the incoming call as being “unknown”, because the indicator 213 on the mobile phone 212 will identify the incoming call as being an international call.

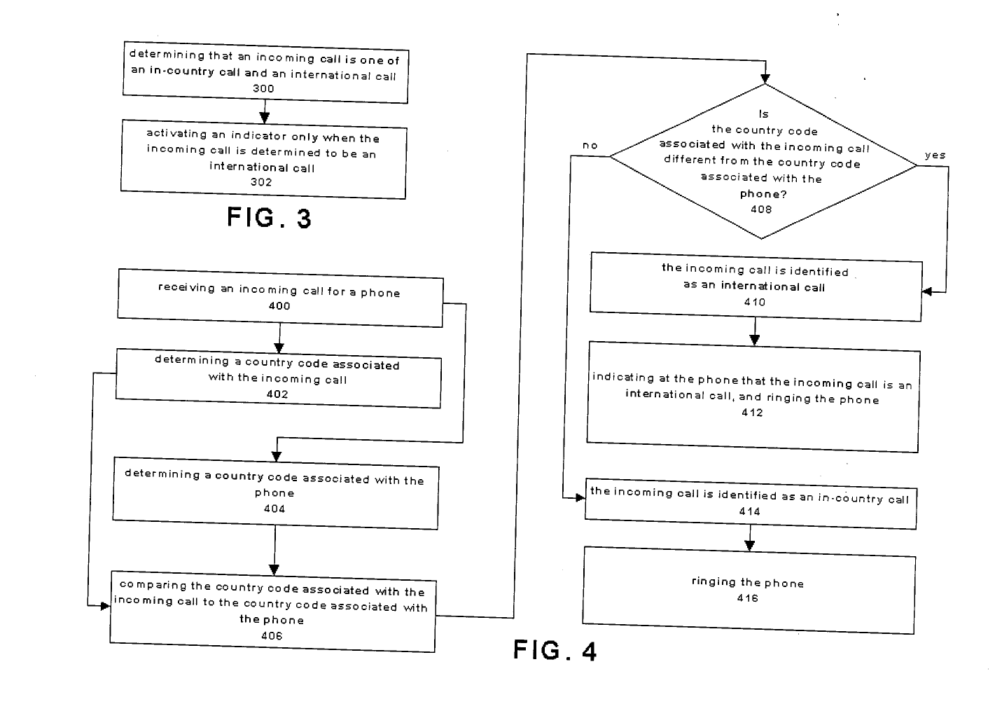

FIG. 3 is a block diagram depicting an embodiment of the present method. In this embodiment of the method is a telecommunications network for indicating that an incoming call is an international call, the method has the steps of: determining that an incoming call is one of an in-country call and an international call (step 300); and activating an indicator only when the incoming call is determined to be an international call (step 302).

FIG. 4 is a block diagram depicting another embodiment of the present method. In this embodiment of the method in a telecommunications network for indicating that an incoming call is an international call, the method has the steps of: receiving, in a telecommunication network, an incoming call for a mobile phone (step 400); determining a country code associated with the incoming call (step 402); determining a country code associated with the mobile phone (step 404); comparing the country code associated with the incoming call to the country code associated with the mobile phone (step 406); determining whether the country code associated with the incoming call different from the country code associated with the mobile phone (step 408); determining that the incoming call is an international call, when the country code associated with the incoming call is different from the country code associated with the mobile phone (step 410), and indicating at the called party's phone that the incoming call is an international call, and ringing the phone (step 412); and determining that the incoming call is an in-country call, when the country code associated with the incoming call substantially matches the country code associated with the mobile phone (step 414), and ringing the mobile phone (step 416).

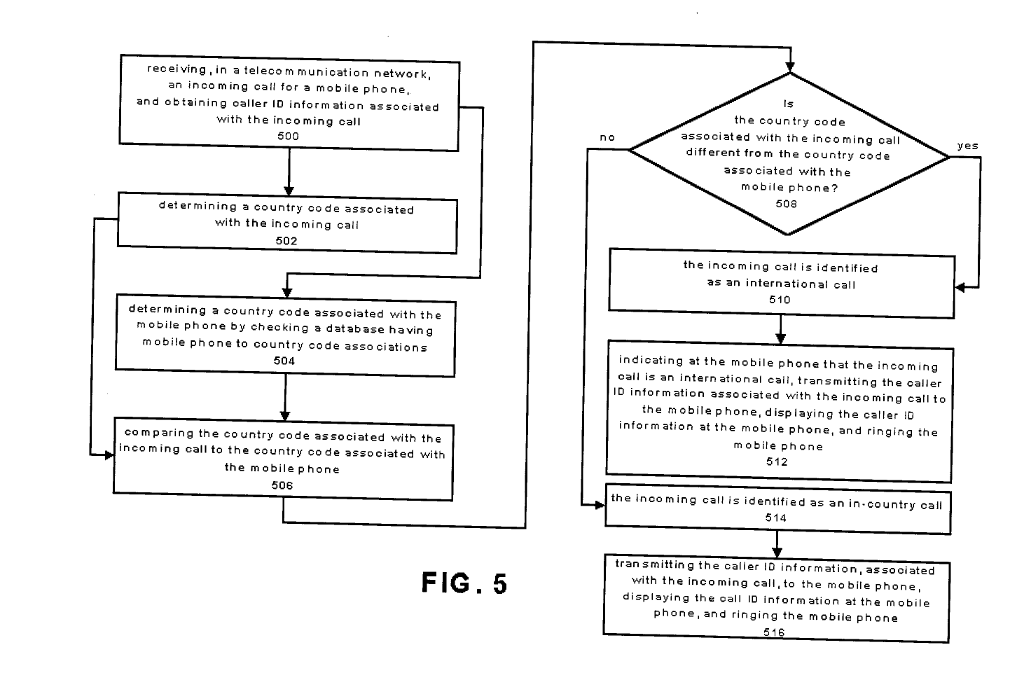

FIG. 5 is a block diagram depicting yet another embodiment of the present method. In this embodiment of the method in a telecommunications network for indicating that an incoming call is an international call, the method has the steps of: receiving, in a telecommunication network, an incoming call for a mobile phone and obtaining caller ID information associated with the incoming call (step 500); determining a country code associated with the incoming call (step 502); determining a country code associated with the mobile phone (step 504) by checking a database having mobile phone to country code associations; comparing the country code associated with the incoming call to the country code associated with the mobile phone (step 506); determining whether the country code associated with the incoming call different from the country code associated with the called party's mobile phone (step 508); determining that the incoming call is an international call, when the country code associated with the incoming call is different from the country code associated with the mobile phone (step 510), and indicating at the phone that the incoming call is an international call, transmitting the caller ID information associated with the incoming call to the mobile phone, displaying the call ID information at the mobile phone, and ringing the mobile phone (step 512); and determining that the incoming call is an in-country call, when the country code associated with the incoming call substantially matches the country code associated with the mobile phone (step 514), transmitting the caller ID information, associated with the incoming call, to the mobile phone, displaying the call ID information at the mobile phone, and ringing the mobile phone (step 516).

The present system and method may be used with non-mobile phones, as well as, mobile phones Also, different types of data storage devices may be used with the present method and system. For example, the data storage device may be one or more of a magnetic, electrical, optical, biological, and atomic data storage medium. The present invention overcomes the drawbacks of the prior art and provides an improved method and system in a telecommunications network for indicating, at a mobile phone, that an incoming call is an international call.

The method and system of the present invention may be implemented in hardware, software, or combinations of hardware and software. In a software embodiment, portions of the present invention may be computer program products embedded in computer readable medium. Portions of the system may employ and/or comprise a set and/or series of computer instructions written in or implemented with any of a number of programming languages, as will be appreciated by those skilled in the art.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. A method for indicating that an incoming call is an international call, said method comprising the steps of:
determining that an incoming call is of an in-country call or an international call; and
activating as indicator only when the incoming call is determined to be an international call.

2. The method of claim 1 further comprising in the steps of:
receiving, in a telecommunication network, an incoming call for a called party's mobile phone;
determining a country code associated with the incoming call;
determining a country code associated with the called party's mobile phone;
comparing the country code associated with the incoming call to the country code associated with the mobile phone;
determining that the incoming call is an international call, when the country code associated with the incoming call is different from the country code associated with the mobile phone; and
determining that the incoming call is an in-country call, when the country code associated with the incoming call substantially matches the country code associated with the mobile phone.

3. The method of claim 2 further comprising in the step of determining that the incoming call is an in-country call, when the country code associated with the incoming call substantially matches the country code associated with the mobile phone; ringing the mobile phone; and transmitting caller ID information, associated with the incoming call, to the mobile phone.

4. The method of claim 2 further comprising in the step of determining that the incoming call is an international call, when the country code associated with the incoming call is different from the country code associated with the mobile phone; indicating at the mobile phone that the incoming call is an international call; and transmitting caller ID information, associated with the incoming call, to the mobile phone.

5. The method of claim 4 wherein the caller ID information indicates that the number and name associated with the incoming call is unknown.

6. The method of claim 2 further comprising in the step of determining a country code associated with the mobile phone; checking a database having mobile phone to country code associations.

7. The method of claim 2 further comprising in the step of determining a country code associated with the incoming call from data attached to the incoming call.

8. A method in a telecommunications network for indicating, on a mobile phone operatively connected to the telecommunications network, that an incoming call is an international call, said method comprising the steps of:
receiving, in a telecommunication network, an incoming call for a mobile phone;
determining a country code associated with the incoming call;
determining a country code associated with the mobile phone being called;
comparing the country code associated with the incoming call to the country code associated with the mobile phone;
determining that the incoming call is an international call, when the country code associated with the incoming call is different from the country code associated with the mobile phone, and indicating at the mobile phone that the incoming call is an international call, and ringing the mobile phone; and
determining that the incoming call is an in-country call, when the country code associated with the incoming call substantially matches the country code associated with the mobile phone, and ringing the mobile phone.

9. The method of claim 8 further comprising in the step of determining that the incoming call is an in-country call, when the country code associated with the incoming call substantially matches the country code associated with the mobile phone, and ringing the mobile phone; transmitting caller ID information, associated with the incoming call, to the mobile phone.

10. The method of claim 8 further comprising in the step of determining that the incoming call is an international call, when the country code associated with the incoming call is different from the country code associated with the mobile phone, and indicating at the mobile phone that the incoming call is an international call, and ringing the mobile phone; also transmitting caller ID information, associated with the incoming call, to the mobile phone.

11. The method of claim 10 wherein the caller ID information indicates that a number and name associated with the incoming call is unknown.

12. The method of claim 8 further comprising in the step of determining a country code associated with the mobile phone; checking a database having mobile phone to country code associations.

13. The method of claim 8 further comprising in the step of determining a country code associated with the incoming call from data attached to the incoming call.

14. A system in a telecommunications network for indicating, on a mobile phone operatively connected to the telecommunications network, that an incoming call is an international call, said system comprising:
data indicative of a country code associated with the incoming call;
a database having mobile phone to country code associations;
data contained in the database indicative of a country code associated with the mobile phone;
mobile switching center operatively connected to the database;
comparison module that receives the data indicative of the country code associated with the incoming call and the data in indicative of the country code associated with the mobile phone, the comparison module operatively connected to the mobile switching center; and
an indicator at the mobile phone that signals, when the country code associated with the incoming call is different from the country code associated with the mobile phone, that the incoming call is an international call, the indicator operatively connected to the comparison module in the mobile switching center.

15. The system of claim 14 further comprising:
a caller ID system that outputs caller ID information for an incoming call;
a caller ID display at the mobile phone that displays the caller ID information for the incoming call.

16. The system of claim 15 wherein the caller ID information indicates that a number and name associated with the incoming call is unknown.

17. The system of claim 14 wherein the indicator is at least one of a visual display, an audio display and a vibration effect.

18. The system of claim 14 wherein the comparison module is one of integrated in the mobile switching center and operatively connected to the mobile switching center as a separate module.
